(19) United States
(12) Patent Application Publication
(10) Pub. No.: US 2008/0133586 A1
(43) Pub. Date: Jun. 5, 2008

(54) Ontology-based modification of structured representations of properties

(75) Inventors: Sailesh Sathish, Tampere (FI); Prabhakar Marnadi, Redmond, WA (US); Bennett David Marks, Carlisle, MA (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/607,822

(22) Filed: Nov. 30, 2006

(51) Int. Cl. G06F 17/30

(52) U.S. Cl. 707/103 R

(57) ABSTRACT

A request for modification of a structured representation of properties is received, wherein the modification comprises one of adding a specific property to the structured representation of properties, removing a specific property from the structured representation of properties, and changing a specific property in the structured representation of properties. Based on an ontology for the structured representation of properties, it is determined where the specific property has to be added to, removed from or changed in the structured representation of properties to satisfy the request.

### FIELD OF THE INVENTION

This invention relates to methods, apparatuses and computer-readable media in the context of structured representation of properties.

### BACKGROUND OF THE INVENTION

Structured representation of properties is for instance targeted with the Delivery Context Interfaces (DCI) framework as currently under development by the World Wide Web Consortium (W3C). The idea behind this DCI framework is that applications, such as for instance multimedia or web browsing applications that may for instance be rendered by a mobile phone are generally designed in a device-independent manner and thus have to function with a plurality of devices, i.e. in a plurality of heterogeneous environments caused by varying device capabilities, for instance varying display types and sizes. Even for one specific device type, rendering environments may be time-variant, for instance due to varying network strength or decreasing battery power. It is thus advantageous that applications are provided with access methods allowing to determine a device's persistent (static) and transient (dynamic) properties, so that content can be adapted to a particular device context (defined in terms of static and transient properties) accordingly.

The W3C's specification “Delivery Context: Interfaces (DCI) Accessing Static and Dynamic Properties”, available from “http://www.w3.org/TR/2005/WD-DPF-20051111”, provides a Document Object Model (DOM) based interface access to device properties so that device properties are accessible via scripts running in a browser or other mechanisms that support DOM based interfaces. Such an interface can provide dynamic access to a hierarchy of properties (the DCI tree), which may for instance represent the current device capabilities, the device configuration, user preferences and environmental conditions. It uses an event model for indicating the dynamic nature of properties and values providing notifications to interested parties.

This DOM based interface is essentially a “consumer” application programming interface that describes how context data consumers (e.g. applications) can access device properties that are contained in the hierarchically structured DCI tree.

However, there exists no application programming interface allowing context data providers to modify the DCI tree, i.e. to add, remove or change properties in the DCI tree. This is at least partially due to the fact that context data providers do generally not know where properties are contained in the DCI tree. Furthermore, there may be a need to maintain access rights and security policies for such modifications of the DCI tree.

### SUMMARY OF THE INVENTION

As a first exemplary embodiment of the invention, a method is proposed, said method comprising receiving a request for modification of a structured representation of properties, said modification comprising one of adding a specific property to said structured representation of properties, removing a specific property from said structured representation of properties, and changing a specific property in said structured representation of properties; and determining, based on an ontology for said structured representation of properties, where said specific property has to be added to, removed from or changed in said structured representation of properties to satisfy said request.

Said properties may for instance be properties of a device that is capable of rendering applications, such as for instance multimedia and/or web applications. Said properties may for instance comprise current device capabilities, the device configuration, user preferences and environmental conditions. Therein, said properties may be persistent or transient properties.

Said structured representation of properties may for instance be a hierarchical arrangement of said properties, for instance in the shape of a tree with nodes, wherein said nodes then represent properties.

Said request for modification of said structured representation of properties may for instance be launched by a context data provider, for instance because it is display size and the transmission capacity and may accordingly adapt the rendering process.

The method according to the first exemplary embodiment of the invention may further comprise checking access rights with respect to modification of said structured representation of properties. Said access rights may for instance prescribe which units are allowed to request modifications of said structured representation of properties, and/or which properties in said structured representation of properties may be modified.

According to the first exemplary embodiment of the invention, said ontology may describe how said representation of properties should be structured and where a property should reside in said structured representation of properties.

According to the first exemplary embodiment of the invention, said ontology additionally may describe relations between properties in said structured representation of properties.

According to the first exemplary embodiment of the invention, said ontology may be described by an ontology language.

According to the first exemplary embodiment of the invention, said ontology language may comprise one of the Web Ontology Language, the DARPA Agent Markup Language with Ontology Inference Layer, the Resource Description Framework or the RDF Schema.

According to the first exemplary embodiment of the invention, said modification of said structured representation of properties may comprise adding a specific property to said structured representation of properties, and said method may further comprise: checking, if an instance exists at the position in said structured representation of properties determined by said determining; creating, if it is found that no instance exists at said determined position, a new instance, and granting access to said new instance for at least partial modification.

According to the first exemplary embodiment of the invention, said modification of said structured representation of properties may comprise changing a specific property in said structured representation of properties, and said method may further comprise: checking, if an instance exists at the position in said structured representation of properties determined by said determining; and granting, if it is found that an instance exists at said determined position, access to said existing instance for at least partial modification.

According to the first exemplary embodiment of the invention, said modification of said structured representation of properties may comprise removing a specific property from said structured representation of properties, and said method may further comprise: checking, if an instance exists at the position in said structured representation of properties determined by said determining; and granting, if it is found that an said structured representation of properties to satisfy said request.

Thus a context data provider, requesting that a property is added to, removed from or changed in said structured representation, does not necessarily need to know where properties are located in said structured representation of properties. In addition to said determining, pointers to instances in the structured representation of properties that have to be added, changed or removed may be handed to the requesting unit for modification. Alternatively, a unit that performs said determining may perform the modification of said instances itself to finalize the modification of the structured representation of properties.

In this way, it is ensured that modification of said structured representation of properties is performed in compliance with the description for said structured representation of properties as set forth in said ontology. This preserves the topology and integrity of the structured representation of properties.

According to the first exemplary embodiment of the invention, said properties may at least partially affect applications and may at least partially be queried from said structured representation of properties by said applications. For instance, a web browsing application may be affected by the display size and transmission capacity of the device on which said application is rendered, so that it may be advantageous that said web browsing application may retrieve information on the desired to add a property to said structured representation of properties.

Said ontology for said structured representation of properties may describe all the hierarchies in said structured representation of properties, for instance logical hierarchies such as for instance software properties, hardware properties, location properties, and the set of properties that would fit under each of said hierarchies. Said ontology may for instance be a file that describes the way properties should be structured, and where within a hierarchy each property should reside. Said structured representation of properties then may be understood as an instantiation of said ontology. Said ontology may allow properties to logically reside within more than one sub-tree of a tree-like structured representation of properties and may describe such relations. Said ontology may describe the entire set of vocabularies for properties that can be exposed to applications that retrieve properties from said structured representation of properties. Said ontology may be partly formed by ontologies such as UAProf schema or Dynamic Profile Extension (ongoing Open Mobile Alliance work). Further parts of said ontology may be built by device manufacturers. Said ontology may further be extensible in that a device manufacturer may extend the vocabulary based on new properties that may emerge.

Based on said ontology for said structured representation of properties, it is determined where said specific property has to be added to, removed from or changed in According to the second exemplary embodiment of the invention, said ontology may be described by an ontology language.

According to the second exemplary embodiment of the invention, said ontology language may comprise one of the Web Ontology Language, the DARPA Agent Markup Language with Ontology Inference Layer, the Resource Description Framework or the RDF Schema.

According to the second exemplary embodiment of the invention, said delivery context interfaces tree may be based on a document object model. Said document object model may be an application programming interface for accessing Hypertext Markup Language (HTML) and Extended Markup Language (XML) documents and may for instance be a document object model as standardized by the W3C.

Therein, it is understood that the description of the features and advantages as presented with respect to the preceding exemplary embodiment of the invention also applies to this second exemplary embodiment of the invention.

As a third exemplary embodiment of the invention, a computer-readable medium having a computer program stored thereon is proposed, said computer-readable medium comprising: instructions operable to cause a processor to receive a request for modification of a structured representation of properties, said modification comprising one of adding a specific property to said structured representation of properties, removing a specific property from said structured representation of properties, and changing a specific property in said structured representation of properties; and instructions operable to cause a processor to determine, based on an ontology for said structured representation of properties, where said specific property has to be added to, removed from or changed in said structured representation of properties to satisfy said request.

According to the third exemplary embodiment of the invention, said properties may at least partially affect applications and may at least partially be queried from said structured representation of properties by said applications.

Therein, it is understood that the description of the features and advantages as presented with respect to the preceding exemplary embodiments of the invention also applies to this third exemplary embodiment of the invention.

As a fourth exemplary embodiment of the invention, an apparatus is proposed, said apparatus comprising: a memory unit configured to store an ontology for a structured representation of properties; a provider interface configured to receive a request for modification of said structured representation of properties, said modification comprising one of adding a specific property to said structured representation of properties, removing a specific property from said structured representation of properties, and changing a specific property in said structured representation of instance exists at said determined position, access to said existing instance for removal.

As a second exemplary embodiment of the invention, a method is proposed, said method comprising: receiving a request for modification of a delivery context interfaces tree, said modification comprising one of adding a specific property to said delivery context interfaces tree, removing a specific property from said delivery context interfaces tree, and changing a specific property in said delivery context interfaces tree; and determining, based on an ontology for said delivery context interfaces tree, where said specific property has to be added to, removed from or changed in said delivery context interfaces tree to satisfy said request. This delivery context interfaces tree may for instance be a delivery context interfaces tree as standardized by the W3C.

According to the second exemplary embodiment of the invention, said ontology may describe how said delivery context interfaces tree should be structured and where a property should reside in said delivery context interfaces tree.

According to the second exemplary embodiment of the invention, said ontology may additionally describe relations between properties in said delivery context interfaces tree. properties; a managing unit configured to determine, based on said ontology, where said specific property has to be added to, removed from or changed in said structured representation of properties to satisfy said request.

The fourth exemplary embodiment of the invention may further comprise: an interface configured to provide said managing unit access to said structured representation of properties.

According to the fourth exemplary embodiment of the invention, said properties may at least partially affect applications and may at least partially be queried from said structured representation of properties by said applications.

The fourth exemplary embodiment of the invention may further comprise: a second memory unit configured to store security and access policies, wherein said managing unit may further be configured to interface with said second memory unit and to check access rights with respect to modification of said structured representation of properties based on said security and access policies.

According to the fourth exemplary embodiment of the invention, said ontology may describe how said structured representation of properties should be structured and where a property should reside in said structured representation of properties.

According to the fourth exemplary embodiment of the invention, said ontology may additionally describe relations between properties in said structured representation of properties.

According to the fourth exemplary embodiment of the invention, said ontology may be described in an ontology language.

According to the fourth exemplary embodiment of the invention, said ontology language may comprise one of the Web Ontology Language, the DARPA Agent Markup Language with Ontology Inference Layer, the Resource Description Framework or the RDF Schema.

According to the fourth exemplary embodiment of the invention, said structured representation of properties may be a delivery context interfaces tree.

According to the fourth exemplary embodiment of the invention, said delivery context interfaces tree may be based on a document object model.

According to the fourth exemplary embodiment of the invention, said apparatus is one of a multimedia device, a mobile phone, a computer and a personal digital assistant.

According to the fourth exemplary embodiment of the invention, said apparatus may be a module that is connected to a second apparatus that is configured to provide applications access to said structured representation of properties.

Therein, it is understood that the description of the features and advantages as presented with respect to the preceding exemplary embodiments of the invention also applies to this fourth exemplary embodiment of the invention.

As a fifth exemplary embodiment of the present invention, an apparatus is proposed, said apparatus comprising: means for storing an ontology for a structured representation of properties; means for receiving a request for modification of said structured representation of properties, said modification comprising one of adding a specific property to said structured representation of properties, removing a specific property from said structured representation of properties, and changing a specific property in said structured representation of properties; means for determining, based on said ontology, where said specific property has to be added to, removed from or changed in said structured representation of properties to satisfy said request.

The fifth exemplary embodiment of the invention may further comprise: means for providing said managing unit access to said structured representation of properties.

Therein, it is understood that the description of the features and advantages as presented with respect to the preceding exemplary embodiments of the invention also applies to this fifth exemplary embodiment of the invention.

As a sixth exemplary embodiment of the invention, an apparatus is proposed, said apparatus comprising: a memory unit configured to store an ontology for a delivery context interfaces tree; a provider interface configured to receive a request for modification of said delivery context interfaces tree, said modification comprising one of adding a specific property to said structured delivery context interfaces tree, removing a specific property from said delivery context interfaces tree, and changing a specific property in said delivery context interfaces tree; a managing unit configured to determine, based on said ontology, where said specific property has to be added to, removed from or changed in said delivery context interfaces tree to satisfy said request.

The sixth exemplary embodiment of the invention may further comprise: an interface configured to provide said managing unit access to said delivery context interfaces tree.

Therein, it is understood that the description of the features and advantages as presented with respect to the preceding exemplary embodiments of the invention also applies to this sixth exemplary embodiment of the invention.

It is furthermore understood that the present invention also allows for all features of the above-described embodiments to be combined with each other.

### BRIEF DESCRIPTION OF THE FIGURES

In the figures show:

FIG. 1: a schematic block diagram of an exemplary embodiment of an apparatus according to the invention;

FIG. 2: an exemplary embodiment of a delivery context interfaces tree;

FIG. 3: a flowchart of a first exemplary embodiment of a method according to the present invention;

FIG. 4: a flowchart of a second exemplary embodiment of a method according to the present invention; and

FIG. 5: a flowchart of a third exemplary embodiment of a method according to the present invention.

### DETAILED DESCRIPTION OF THE INVENTION

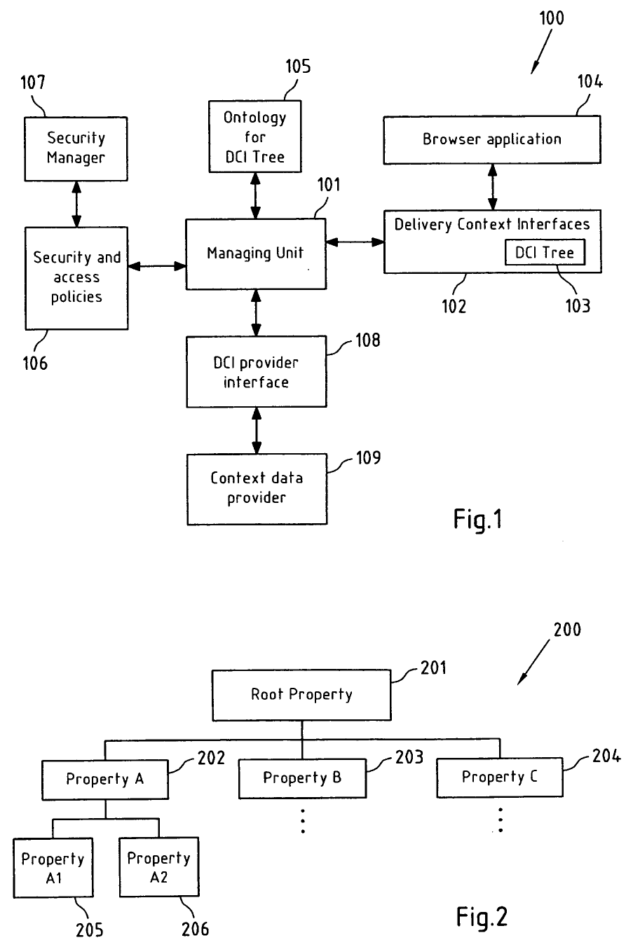

FIG. 1 depicts a schematic block diagram of an exemplary embodiment of an apparatus 100 according to the present invention. Said apparatus may for instance be a mobile phone or a part thereof.

Apparatus 100 comprises a managing unit 101, which is configured to interface with a Delivery Context Interfaces (DCI) unit 102. DCI, as implemented by DCI unit 103, is a World Wide Web Consortium (W3C) activity that uses a Document Object Model (DOM) based interface to build a hierarchy of properties, which is embodied as DCI tree 103.

An example of such a DCI tree 103 is exemplarily depicted in FIG. 2. Therein, DCI tree 200 comprises a root property 201, and a plurality of properties 202 . . . 206 that are hierarchically arranged below root property 201. Therein, properties 202, 203 and 204 form a first hierarchical layer, and properties 205 and 206 form a second hierarchical layer below said first hierarchical layer. In this way, it is possible to arrange properties in a structured way.

Returning to FIG. 1, DCI tree 103 is, via DCI unit 102, accessible for browser application 104, so that browser application 104 may query properties from DCI tree 103 and may attach handlers to the nodes in the DCI tree 103 for getting notifications on particular property changes. In this way, browser application 104 may adapt its functioning to the persistent and/or transient properties of apparatus 100, such as for instance network bandwidth and/or display size. DCI is thus basically a consumer application interface that describes the interfaces that consumers of context data can use for data access.

In apparatus 100, managing unit 101 is configured to have access to ontology unit 105. Said ontology unit 105 may for instance be a memory unit that stores an ontology for DCI tree 103.

Generally, an ontology may be considered to describe the concepts used in a particular domain that is machine understandable and may also provide the relations among the concepts used. An ontology may for instance be described using standard ontology languages such as Web Ontology Language (OWL), the DARPA Agent Markup Language with Ontology Inference Layer (DAML+OIL), the Resource Description Framework (RDF) or the RDF Schema (RDFS). Such ontology languages allow describing structures for instance by stating that one node is a parent of another node, or that nodes or node properties are equivalent to each other.

The ontology comprised in ontology unit 105 may describe the entire set of vocabularies for properties that can be exposed by DCI unit 102 to the calling applications, such as for instance to browser application 104. This ontology may describe all the hierarchies (logical such as software, hardware, location etc.) and the set of properties that would fit under each hierarchy. Therein, the ontology may be formed partly from standard ontologies such as UAProf schema, or Dynamic Profile Extension (ongoing Open Mobile Alliance, OMA work), to name but a few. The rest of the ontology may be built by device manufacturers. The ontology may be extensible in that the device manufacturer may extend the vocabulary based on new properties that would emerge.

Basically, the ontology may be imagined as a file that describes the way properties should be structured and where in said DCI tree 103, each property should reside. In addition, there may be properties that may logically reside within more than one sub tree and the ontology may also describe such relations.

For instance, with respect to the exemplary DCI tree 200 illustrated in FIG. 2, an ontology may define, for all or some properties 201 . . . 206 in said DCI tree 200, the corresponding vocabularies being exposed to querying applications. For instance, a vocabulary associated with property 202 may be “Screen size, display size, window size” or similar. It may also be defined what types of properties are allowed in each hierarchical layer. For instance, in the layer containing properties 202 . . . 204, only hardware-related properties may be allowed, and said ontology may prescribe a fixed set of hardware components that are considered “hardware-related”.

In apparatus 100, managing unit 101 is further configured to interface with security and access policies unit 106. This unit 106 may for instance be embodied as a memory unit and describes security and access rights policies with respect to the properties in the DCI tree 103. These policies can be managed through security manager 107, which provides access to the security and access policies unit 106 to service/network providers and device manufacturers. In this way, control of who gets what type of access to where in the DCI tree 102 can be exerted by the service/network providers and device manufacturers.

Apparatus 100 is further furnished with a DCI provider interface 108, via which requests for modification of the DCI tree 103 can be addressed to managing unit 101. DCI provider interface 108 is thus the interface that context data providers 109 can use to gain access to the DCI tree 103 in order to create new nodes corresponding to the property, update values, update metadata, remove nodes, values, etc. Since it is desirable that providers, which are generally not furnished with knowledge on the structure of the DCI tree, get access to the correct nodes in the DCI tree 103, that this access is provided based on security and access policies, that integrity and topology of the DCI tree 103 are maintained, and that request for modification of the DCI tree 103 are managed by managing unit 101 under consideration of the ontology for DCI tree 103.

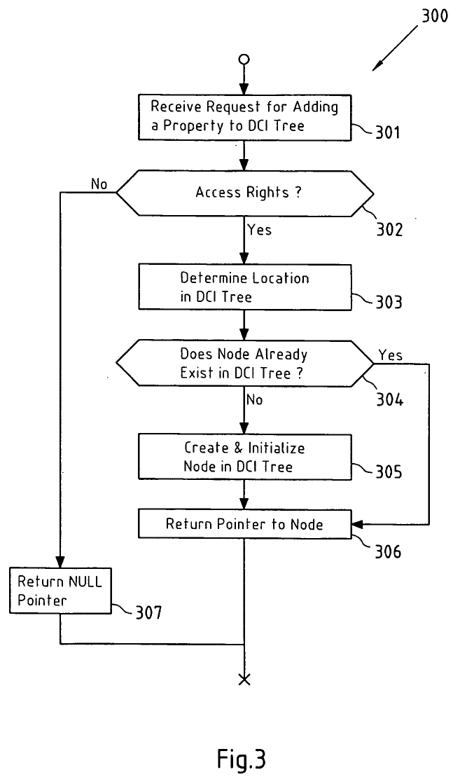

FIG. 3 depicts a flowchart 300 of a first exemplary embodiment of a method according to the present invention. The steps in this flowchart may for instance be performed by managing unit 101 of FIG. 1 when receiving a request for modification of the DCI tree 103, in particular a request for adding a property to the DCI tree 103.

In a first step 301, a request for adding a property to the DCI tree is received by managing unit 101, wherein said request has been launched by context data providers 109 via the DCI provider interface 108 (see FIG. 1). Said request comprises property metadata for the property that is to be added, wherein said property metadata may for instance be RDFS metadata or an OWL-S description, wherein OWL-S is an OWL-based Web service ontology.

In a second step 302, managing unit 101 accesses the security and access policies unit 106 and gets the access rights policies for the particular type of property. If no access rights exist, a NULL pointer is returned via the DCI provider interface 108 in step 307.

Otherwise, in a step 303, managing unit 101 accesses the ontology file (maintained in ontology unit 105) for DCI tree 103 and decides where in the DCI tree 103 the particular property should be placed.

In a step 304, managing unit 101 accesses the DCI tree 103 comprised in the DCI unit 102 and determines if, at the DCI tree position determined in step 303, already a node exists. If this is the case, a pointer to the existing node is returned via the DCI provider interface in a step 306. In this way, the context data provider 109 may be informed that, instead of adding a new node, changing of an existing node to have the desired properties may be performed. Alternatively, instead of directly returning the pointer to the existing node (see step 306), it may be checked (not shown in FIG. 3) before if there is an active context data provider for that existing node. If this would not be the case, the existing pointer could be returned as illustrated in step 306. However, if this would be the case, it might be decided whether to retain the active context data provider and to create a new node for the requesting context data provider, or to replace the context data provider.

If, in step 304, it is determined that the node does not already exist, a new node in the DCI tree 103 is created by the managing unit 101 in a step 305. When creating said node, the topology and integrity constraints as laid down in the ontology for the DCI tree 103 are obeyed by managing unit 101. Said creating of said node may comprise initialization of the node with parent node information.

In a step 306, a pointer to the new node is then passed to the context data provider for modification via the DCI provider interface.

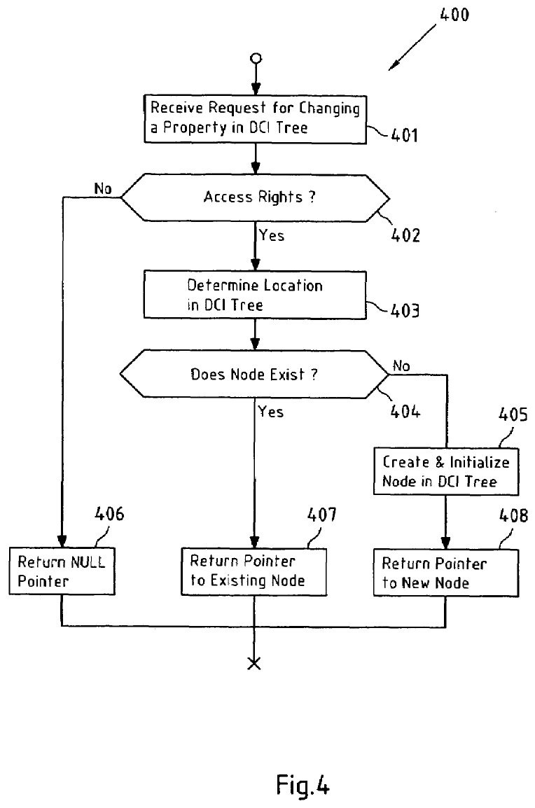

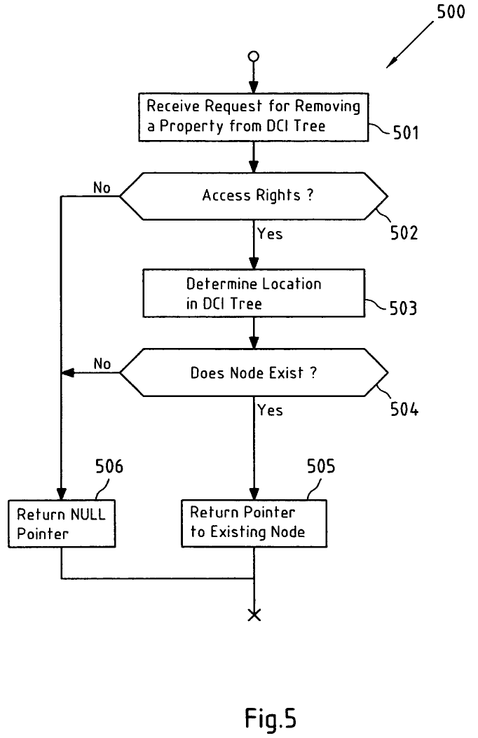

FIG. 4 depicts a flowchart 400 of a second exemplary embodiment of a method according to the present invention. The steps in this flowchart may for instance be performed by managing unit 101 of FIG. 1 when receiving a request for changing a property to the DCI tree 103.

In a first step 401, a request for changing a property in the DCI tree is received by managing unit 101 from context data providers 109 via the DCI provider interface 108 (see FIG. 1). Said request comprises property metadata for the property that is to be changed, for instance as RDFS metadata or as an OWL-S description.

In a second step 402, managing unit 101 accesses the security and access policies unit 106 and gets the access rights policies for the particular type of property. If no access rights exist, a NULL pointer is returned via the DCI provider interface 108 in step 406.

Otherwise, in a step 403, managing unit 101 accesses the ontology file (maintained in ontology unit 105) for DCI tree 103 and decides where in the DCI tree 103 the property that is to be changed resides.

In a step 404, managing unit 101 accesses the DCI tree 103 comprised in the DCI unit 102 and determines if, at the DCI tree position determined in step 403, a node exists. If this is the case, in a step 407, a pointer to this existing node is returned to the context data provider 109 for modification via the DCI provider interface 108.

If no node exists, the property that shall be changed is not yet comprised in the DCI tree 103. Consequently, in a step 405, a corresponding node is created and initialized, and in a step 408, a pointer to this new node is returned to the context data provider 109 for modification via the DCI provider interface 108.

FIG. 5 depicts a flowchart 500 of a third exemplary embodiment of a method according to the present invention. The steps in this flowchart may for instance be performed by managing unit 101 of FIG. 1 when receiving a request for removing a property from the DCI tree 103.

In a first step 501, a request for removing a property from the DCI tree is received by managing unit 101 from context data providers 109 via the DCI provider interface 108 (see FIG. 1).

In a second step 502, managing unit 101 accesses the security and access policies unit 106 and gets the access rights policies for the particular type of property. If no access rights exist, a NULL pointer is returned via the DCI provider interface 108 in step 506.

Otherwise, in a step 503, managing unit 101 accesses the ontology file (maintained in ontology unit 105) for DCI tree 103 and decides where in the DCI tree 103 the property that is to be removed resides.

In a step 504, managing unit 101 accesses the DCI tree 103 comprised in the DCI unit 102 and determines if, at the DCI tree position determined in step 503, a node exists. If this is the case, in a step 505, a pointer to this existing node is returned to the context data provider 109 for removal via the DCI provider interface 108.

If no node exists, the property that shall be removed is not comprised in the DCI tree 103. Consequently, in a step 506, a NULL pointer is returned to the context data providers 109 via DCI provider interface 108.

It can thus readily be seen that context data providers are enabled to add, change and remove properties in the DCI tree without requiring any knowledge on the structure of the DCI tree. To achieve addition, change or removal of properties in the DCI tree, only a corresponding request, in case of adding and changing along with property metadata, has to be launched via the DCI provider interface 108. This is due to the fact that addition, change and removal of the property in the DCI tree in terms of integrity issues, hierarchy management and access rights thus is managed by management unit 101.

In the exemplary embodiments of the invention described before, the DCI provider interface 108 or managing unit 101 (see FIG. 1) may not permit the context data providers 109 to directly start modifying the DCI tree 103, for instance by adding properties to the DCI tree 103. To increase performance, context data providers 109 may only be allowed to start adding properties upon reception of a start event from the DCI provider interface 108 or management unit 101. This event may for instance only be generated and sent to the data context providers 109 when a consumer, such as for instance browser application 104, queries the DCI tree 103 for a specific property. The property though would have a node in the DCI tree 103 with the metadata interface describing the services of that property that can be queried by the consumer.

The invention has been described above by means of exemplary embodiments. It should be noted that there are alternative ways and variations which will be evident to any person skilled in the art and can be implemented without deviating from the scope and spirit of the appended claims. In the claims, means-plus-function clauses are intended to cover the structures described herein as performing the recited function and not only structural equivalents, but also equivalent structures.

1. A method, comprising:
receiving a request for modification of a structured representation of properties, said modification comprising one of adding a specific property to said structured representation of properties, removing a specific property from said structured representation of properties, and changing a specific property in said structured representation of properties; and
determining, based on an ontology for said structured representation of properties, where said specific property has to be added to, removed from or changed in said structured representation of properties to satisfy said request.

2. The method according to claim 1, wherein said properties at least partially affect applications and can at least partially be queried from said structured representation of properties by said applications.

3. The method according to claim 1, further comprising:
checking access rights with respect to modification of said structured representation of properties.

4. The method according to claim 1, wherein said ontology describes how said structured representation of properties should be structured and where a property should reside in said structured representation of properties.

5. The method according to claim 4, wherein said ontology additionally describes relations between properties in said structured representation of properties.

6. The method according to claim 1, wherein said ontology is described by an ontology language.

7. The method according to claim 6, wherein said ontology language comprises one of a Web Ontology Language, a DARPA Agent Markup Language with Ontology Inference Layer, a Resource Description Framework or a Resource Description Framework Schema.

8. The method according to claim 1, wherein said modification of said structured representation of properties comprises adding a specific property to said structured representation of properties, said method further comprising:
checking, if an instance exists at the position in said structured representation of properties determined by said determining; and
creating, if it is found that no instance exists at said determined position, a new instance, and granting access to said new instance for at least partial modification.

9. The method according to claim 1, wherein said modification of said structured representation of properties comprises changing a specific property in said structured representation of properties, said method further comprising:
checking, if an instance exists at a position in said structured representation of properties determined by said determining; and
granting, if it is found that an instance exists at said determined position, access to said existing instance for at least partial modification.

10. The method according to claim 1, wherein said modification of said structured representation of properties comprises removing a specific property from said structured representation of properties, and said method further comprising:
checking, if an instance exists at a position in said structured representation of properties determined by said determining; and
granting, if it is found that an instance exists at said determined position, access to said existing instance for removal.

11. A method, comprising:
receiving a request for modification of a delivery context interfaces tree, said modification comprising one of adding a specific property to said delivery context interfaces tree, removing a specific property from said delivery context interfaces tree, and changing a specific property in said delivery context interfaces tree; and
determining, based on an ontology for said delivery context interfaces tree, where said specific property has to be added to, removed from or changed in said delivery context interfaces tree to satisfy said request.

12. The method according to claim 11, wherein said ontology describes how said delivery context interfaces tree should be structured and where a property should reside in said delivery context interfaces tree.

13. The method according to claim 12, wherein said ontology additionally describes relations between properties in said delivery context interfaces tree.

14. The method according to claim 11, wherein said ontology is described by an ontology language.

15. The method according to claim 14, wherein said ontology language comprises one of a Web Ontology Language, a DARPA Agent Markup Language with Ontology Inference Layer, a Resource Description Framework or a Resource Description Framework Schema.

16. The method according to claim 11, wherein said delivery context interfaces tree is based on a document object model.

17. A computer-readable medium having a computer program stored thereon, the computer program comprising:
instructions operable to cause a processor to receive a request for modification of a structured representation of properties, said modification comprising one of adding a specific property to said structured representation of properties, removing a specific property from said structured representation of properties, and changing a specific property in said structured representation of properties; and
instructions operable to cause a processor to determine, based on an ontology for said structured representation of properties, where said specific property has to be added to, removed from or changed in said structured representation of properties to satisfy said request.

18. The computer-readable medium according to claim 17, wherein said properties at least partially affect applications and can at least partially be queried from said structured representation of properties by said applications.

19. An apparatus, comprising:
a memory unit configured to store an ontology for a structured representation of properties;
a provider interface configured to receive a request for modification of said structured representation of properties, said modification comprising one of adding a specific property to said structured representation of properties, removing a specific property from said structured representation of properties, and changing a specific property in said structured representation of properties; and
a managing unit configured to determine, based on said ontology, where said specific property has to be added to, removed from or changed in said structured representation of properties to satisfy said request.

20. The apparatus according to claim 19, further comprising:
an interface configured to provide said managing unit access to said structured representation of properties.

21. The apparatus according to claim 19, wherein said properties at least partially affect applications and can at least partially be queried from said structured representation of properties by said applications.

22. The apparatus according to claim 19, further comprising:
a second memory unit configured to store security and access policies, wherein said managing unit is further configured to interface with said second memory unit and to check access rights with respect to modification of said structured representation of properties based on said security and access policies.

23. The apparatus according to claim 19, wherein said ontology describes how said structured representation of properties should be structured and where a property should reside in said structured representation of properties.

24. The apparatus according to claim 23, wherein said ontology additionally describes relations between properties in said structured representation of properties.

25. The apparatus according to claim 19, wherein said ontology is described in an ontology language.

26. The apparatus according to claim 25, wherein said ontology language comprises one of a Web Ontology Language, a DARPA Agent Markup Language with Ontology Inference Layer, a Resource Description Framework or a Resource Description Framework Schema.

27. The apparatus according to claim 19, wherein said structured representation of properties is a delivery context interfaces tree.

28. The apparatus according to claim 27, wherein said delivery context interfaces tree is based on a document object model.

29. The apparatus according to claim 19, wherein said apparatus is one of a multimedia device, a mobile phone, a computer and a personal digital assistant.

30. The apparatus according to claim 19, wherein said apparatus is a module that is connected to a second apparatus that is configured to provide applications access to said structured representation of properties.

31. An apparatus, comprising:
means for storing an ontology for a structured representation of properties;
means for receiving a request for modification of said structured representation of properties, said modification comprising one of adding a specific property to said structured representation of properties, removing a specific property from said structured representation of properties, and changing a specific property in said structured representation of properties; and
means for determining, based on said ontology, where said specific property has to be added to, removed from or changed in said structured representation of properties to satisfy said request.

32. The apparatus according to claim 31, further comprising:
means for providing said managing unit access to said structured representation of properties.

33. An apparatus, comprising:
a memory unit configured to store an ontology for a delivery context interfaces tree;
a provider interface configured to receive a request for modification of said delivery context interfaces tree, said modification comprising one of adding a specific property to said structured delivery context interfaces tree, removing a specific property from said delivery context interfaces tree, and changing a specific property in said delivery context interfaces tree; and
a managing unit configured to determine, based on said ontology, where said specific property has to be added to, removed from or changed in said delivery context interfaces tree to satisfy said request.

34. The apparatus according to claim 33, further comprising:
an interface configured to provide said managing unit access to said delivery context interfaces tree.
